(19) United States
(12) Patent Application Publication
(10) Pub. No.: US 2005/0116425 A1
(43) Pub. Date: Jun. 2, 2005

(54) Finned seals for turbomachinery

(76) Inventors: David Paul Blatchford, Rugby (GB); Philip David Hemsley, Rugby (GB)

Correspondence Address: CERMAK & KENEALY LLP, 515 E. BRADDOCK RD, ALEXANDRIA, VA, 22314, US

(21) Appl. No.: 10/994,391

(22) Filed: Nov. 23, 2004

(30) Foreign Application Priority Data
Nov. 25, 2003 (GB) 0327300.0

(51) Int. Cl. F16J 15/34

(52) U.S. Cl. 277/412

(57) ABSTRACT

A seal assembly (50) controls leakage of working fluid through an annular gap (G) between a static component (16) and a rotary component (28) in a turbomachine. The fixed and moving components (16, 28) each have stepped diameters including a plurality of circumferentially and axially extending lands (56, 58) that confront each other across the annular gap (G). They are complementarily formed such that the annular gap is maintained over the axial extent of the seal assembly. Both components (16, 18) are provided with rows of fins (60, 62) which extend circumferentially of the lands and project radially therefrom towards each other. The rows of fins 60 of the static component 16 are preferably unequally spaced apart with respect to the rows of fins 62 of the rotating component 16, so producing a vernier seal arrangement.

This application claims priority under 35 U.S.C. § 119 to Great Britain application number 0327300.0, filed 25 Nov. 2003, by the inventors hereof, the entirety of which is incorporated by reference herein.

### BACKGROUND OF THE INVENTION

1. Field of the Invention

The present invention relates to turbomachinery, and in particular to improvements in finned seals, such as can be used to control flow of fluids through clearances between stationary and rotating components.

2. Brief Description of the Related Art

In turbomachines, such as steam turbines, there is a need to control leakage of the working fluid through annular gaps (clearances) between rotating and stationary components. One known means of controlling leakage of working fluid between rotating and stationary components is the finned seal. In one form, this comprises an axial series of circumferentially extending ribs or fins which project from both the stationary and rotating components towards each other across the annular gap.

### SUMMARY OF THE INVENTION

One of numerous aspects of the present invention includes providing an improved finned seal that can minimise leakage through annular clearances between static and rotating components in turbomachinery while accommodating relative axial movement between such components.

Accordingly, another aspect of the present invention includes providing a seal assembly for controlling leakage of fluid through an annular gap between a rotary component and a static component in a turbomachine, in which the rotary and static components each have stepped diameters comprising a plurality of circumferentially and axially extending lands which confront each other across the annular gap and are complementarily formed such that the annular gap is maintained over the axial extent of the seal assembly, both components being provided with rows of fins which extend circumferentially of the lands and project radially therefrom towards each other, rows of fins on confronting lands being opposed to each other across the gap, the radial dimensions of the opposed fins being sufficient substantially to span the gap when added together.

The annular gap is exemplarily maintained substantially constant in radial dimension over the axial extent of the seal assembly. However, axially successive lands on both components may decrease in diameter stepwise over a first axial extent of the seal assembly and increase in diameter stepwise over a second axial extent of the seal assembly. Alternatively, axially successive lands on both components may increase in diameter stepwise over a first axial extent of the seal assembly and decrease in diameter stepwise over a second axial extent of the seal assembly.

In an exemplary embodiment, each of one or more rows of fins on the rotary component and/or the static component comprises a pair of axially adjacent fins of substantially equal radial extent. Alternatively, each of one or more rows of fins on the rotary component and/or the static component may comprise axially adjacent multiple fins.

Further aspects of the invention will become apparent from a study of the following description.

### BRIEF DESCRIPTION OF THE DRAWINGS

FIG. 1A is a diagrammatic side elevation in broken-away axial section of part of a steam turbine, including a known type of finned seal;

FIG. 1B is a view within the dashed rectangle B of FIG. 1A, diagrammatically illustrating a vernier seal;

FIG. 2 is a view like FIG. 1B but of a vernier seal in accordance with the invention; and

FIGS. 3 and 4 are views like FIG. 2, but showing alternative embodiments of the invention;

### DETAILED DESCRIPTION OF EXEMPLARY EMBODIMENTS

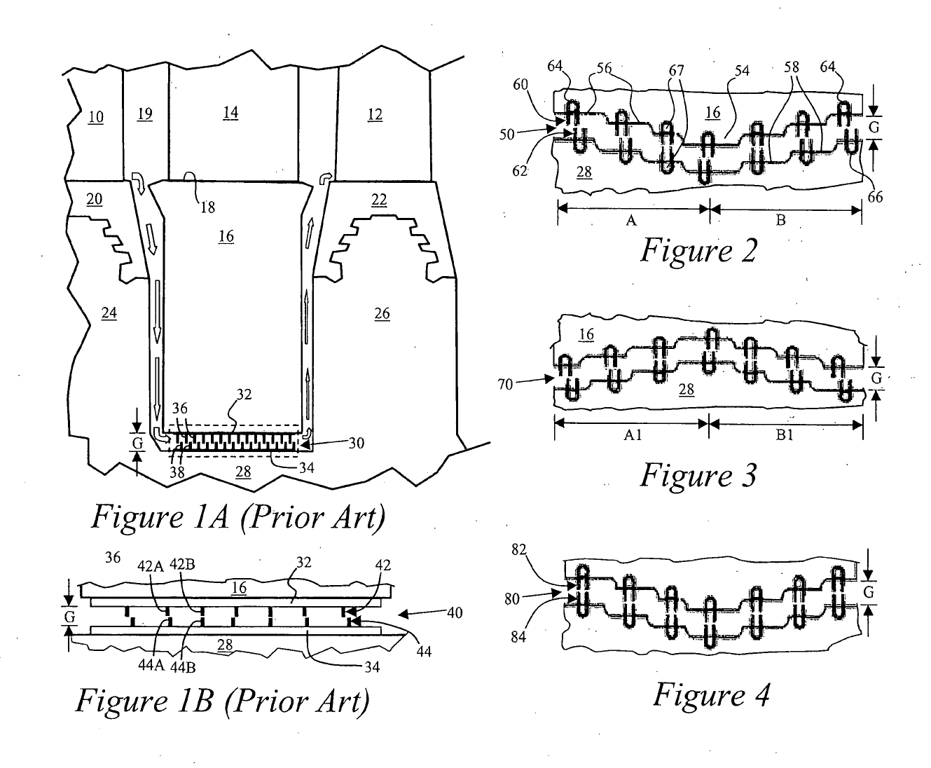

FIG. 1A illustrates part of a steam turbine, comprising two annular rows of moving blades 10, 12 and an annular row of fixed blades 14 between the two rows of moving blades. At their radially inner ends, the fixed blades 14 are joined to an inner shroud ring 16. For convenience of manufacture and assembly, the shroud ring 16, termed the fixed shroud, may be formed as a number of circumferentially extending sectors of an annulus, or as a pair of half-rings. The radially outer surface 18 of the shroud 16 helps define the radially inner boundary of the turbine passage 19.

At their radially inner ends, the moving blades 10, 12 are provided with root portions 20, 22 by which they are attached to the rims of respective rotor discs 24, 26. As shown, the blade root portions 20, 22 are of the re-entrant slot type, the slots having a sectional profile somewhat like a fir-tree. Alternatively, other forms of attachments, such as pinned fingers or dovetails, could be used to secure the moving blades to the rotor discs. The rotor discs 24, 26 extend radially from a cylindrical shaft 28.

During operation of the turbine, some of the steam from the turbine annulus 19 tends to leak around the radially inner end of the fixed shroud 16 (as indicated by the arrows) instead of flowing through the passages between successive blades 14 in the static blade row. To maintain turbine efficiency, it is necessary to control this flow of steam and for this purpose a known type of labyrinth seal assembly 30 is provided. This comprises a radially inner cylindrical surface 32 of the fixed shroud 16 that confronts an outer cylindrical surface 34 of the shaft 28 across a gap G. Extending radially inwards from the surface 32 towards the shaft is an axial series of circumferentially extending fins or ribs 36; similarly, extending radially outwards from the surface 34 towards the fixed shroud 16 is an axial series of circumferentially extending fins or ribs 38. Fins 36 and 38 are axially offset from each other, so that they are interdigitated, thereby presenting steam with a serpentine path of increased flow resistance to reduce leakage.

It will be seen from FIG. 1A that the fins 36 and 38 do not extend all the way across the gap G between the confronting surfaces 32, 34. This prevents the free ends of the fins rubbing against the confronting surfaces 32, 34.

Another type of finned seal 40 suitable for use in the turbine of FIG. 1A is illustrated diagrammatically in FIG. 1B. It again comprises an axial series of circumferentially extending fins or ribs 42, 44 provided on each confronting surface 32, 34 of the static and rotating components 16 and 28, respectively. Fins 42, 44 extend circumferentially of the fixed shroud 16 and the shaft 28 and project radially towards each other. There are the same number of fins 42, 44 on each of the confronting surfaces 32, 34, each fin 42 being opposed to a fin 44 across the gap G. The radial dimensions of the opposed fins do not have to be identical, but when added together must be sufficient to span the gap G effectively, though of course during normal operation there should be a small radial clearance between the free ends of the opposed fins.

It will be seen that some of the opposed fins, e.g., 42A, 44A, are offset from each other across the gap G, while others, e.g., 42B, 44B, are in registration with each other. This is because the ribs 42 on the fixed shroud ring 16 are axially spaced apart from each other by a slightly different amount compared to ribs 44 on the shaft 28. This is characteristic of so-called vernier-type seals, which are designed such that under a defined range of axial positions of the rotating and fixed components relative to each other, there is always at least one sealing rib or fin on one component in registration (or nearly so) with a corresponding rib or fin on the other component, so maintaining restriction of fluid flow through the gap G.

The skilled person will realise that axial movement of a steam turbine rotor relative to the turbine's fixed structure will be due, e.g., to differences in linear thermal expansion between the turbine casing and the rotor, or movement of the rotor in its bearings due to thrust forces transmitted from the turbine blades. The possible range of such axial movement will be known from tests and/or calculation, and therefore the vernier seal will be designed to cope with this specific range of movement.

A disadvantage of the vernier seal of FIG. 1B is that if the gap G is reduced due, e.g., to differential thermal growth in the radial direction between the shaft 28 and the fixed shroud 16, some of the opposing ribs 42 and 44 which happen to be in registration with each other at the time will rub on each other and wear away. This will open up the existing small radial clearances between the free ends of opposing ribs and thereby tend to increase the amount of leakage flow through the seal assembly. This is particularly so because unlike the labyrinth seal of FIG. 1A, the flow of leakage fluid does not have to turn corners in order to get through the clearances, but can flow through the vernier seal of FIG. 1B in a straight line.

Turning now to FIG. 2, there is shown a seal assembly constructed in accordance with the invention. A vernier seal assembly 50 again controls leakage of fluid through the gap G between the fixed and moving components, but unlike FIGS. 1A and 1B, the fin-bearing surfaces 52, 54 of the fixed shroud 16 and the shaft 28 are not of constant diameter but are radially stepped. In this example, the stepped diameters form seven circumferentially and axially extending lands 56 and 58 on the fixed shroud and the shaft, respectively, though more or fewer steps could be provided. The lands confront each other across the annular gap G and the diameters of confronting lands are complementarily dimensioned with respect to each other such that, though stepped, the gap G is substantially constant over the axial extent of the seal assembly. The lands on both the rotor 28 and the fixed shroud 16 are provided with rows of fins 60, 62 which extend circumferentially of the lands and project radially therefrom towards each other such that rows of fins on confronting lands are opposed to each other across the gap G. As in FIG. 1B, the radial dimensions of the opposed fins are sufficient to substantially span the gap when added together.

It will be realised that the steps in diameter of the lands 56 and 58 removes the ability of the leakage fluid to flow in a straight line through the seal, even when some of the fins have been shortened due to rubbing against each other. Hence, the flow resistance of the seal is increased relative to a “straight through” version of the seal without steps.

As will be seen from FIG. 2, axially successive lands on both the rotor and the static shroud ring decrease in diameter stepwise over a first axial extent ‘A’ of the seal assembly and increase in diameter stepwise over a second axial extent ‘B’ of the seal assembly.

From FIG. 2, it is evident that each row of fins 60, 62 in the seal assembly 50, on both the rotor and the fixed shroud ring, is in fact an axially adjacent double fin 60A, 60B and 62A, 62B, having the same radial extents. These double fins comprise the radially projecting free ends of circumferentially extending elongate components which have a substantially U-shaped cross-section. Other arrangements of fins are possible, such as rows comprising single or multiple fins. Furthermore, fins may be constructed as separate components, or be integral with the shroud ring or rotor. Conveniently, the elongate components are strips embedded in grooves 64, 66 formed in the surfaces of the confronting lands 54 and 56, the cross-sectional shape of the grooves being complementary to the U-shaped cross-section of the strips. The strips may be made of any suitable material and are secured in the grooves by caulking 67 or other suitable means.

The benefit of multiple rows of double fins as shown in FIG. 2, is an increase in longevity of the seal and increased effectiveness over a range of axial movement of the rotor. Furthermore, the simple method of making the fins and fixing them into the confronting surfaces of the moving and fixed components means that all the fins can be easily refurbished or replaced during an overhaul of the turbine.

As noted above, one or more of the rows could comprise single fins, this being achieved by the simple expedient of having one limb of the U-shaped strips shorter than the other and level with the surface of the land in which it is embedded.

FIG. 3 shows an alternative arrangement for a seal assembly 70, in which axially successive lands 72, 74 on both the moving and static components increase in diameter stepwise over a first axial extent ‘A1’ of the seal assembly and decrease in diameter stepwise over a second axial extent ‘B1’ of the seal assembly.

It will be realised by the skilled person that the steps in the diameters of adjacent lands need not be equal increments or decrements of diameter, though it will probably still be desirable to maintain a constant radial dimension of the gap G over the axial extent of the seal assembly.

The vernier effect in the vernier seal assembly described above in relation to FIGS. 2 and 3 may be obtained in a variety of ways. The normal way is that the rows of fins on both components are equally spaced apart with respect to fins on the same component, but the spacing on one component differs slightly from the spacing on the other. Alternatively, the rows of fins on either or both components may be unequally spaced apart from each other to obtain an exaggerated vernier effect if such is deemed desirable.

Although a vernier seal arrangement is illustrated in FIGS. 2 and 3 of the accompanying drawings, it is envisaged that provided only a small range of axial movement of the rotating component is required to be accommodated by the seal, the invention could also operate satisfactorily without use of the vernier effect in spacing apart of adjacent rows of fins. That is, as shown in FIG. 4, a seal 80 could utilise spacing between the rows of fins 82, 84 which is identical over the axial extents of the seal assembly and is the same on both the static and rotating components.

Although the focus of the above description has been on use of the invention in connection with an axial flow steam turbine, the skilled person will appreciate that the invention could be applicable to other types of turbomachinery, whether or not steam-driven, including radial flow turbomachines and including radial or axial flow compressors.

List of reference numbers.

10, 12—moving turbine blades

14—fixed turbine blades

16—inner fixed shroud ring

18—radially outer surface of shroud 16

19—turbine passage

20,22—root portions of rotor blades 10, 12

24, 26—rotor discs

28—shaft

30—labyrinth seal

32—inner cylindrical surface of fixed shroud 16

34—outer cylindrical surface of shaft 28

36, 38—fins on surfaces 32, 34

40—vernier seal

42, 44—fins

42A, 44A—opposed fins offset from each other

42B, 44B—opposed fins in registration with each other

50—vernier seal (invention)

52, 54—confronting surfaces of fixed shroud 16 and shaft 28

56, 58—lands

60, 62—fins on lands 56, 58

64, 66—grooves

67—caulking

70, 80—seal assembly

82, 84—fins in seal assembly 80

‘A’, ‘B’—first and second axial extents of the seal assembly in FIG. 2

‘A1’, ‘B1’—first and second axial extents of the seal assembly in FIG. 3

G—gap

While the invention has been described in detail with reference to exemplary embodiments thereof, it will be apparent to one skilled in the art that various changes can be made, and equivalents employed, without departing from the scope of the invention. Each of the aforementioned documents is incorporated by reference herein in its entirety.

1. A seal assembly for controlling leakage of fluid through an annular gap between a rotary component and a static component in a turbomachine, comprising:
a rotary component and a static component each having stepped diameters comprising a plurality of circumferentially and axially extending lands which confront each other across an annular gap therebetween and are complementarily formed such that the annular gap is maintained over an axial extent of the seal assembly, both components including rows of fins which extend circumferentially of the lands and project radially from said lands towards each other, rows of fins on confronting lands being opposed to each other across the gap, the radial dimensions of the opposed fins being sufficient substantially to span the gap when added together.

2. A seal assembly according to claim 1, wherein the annular gap is substantially constant in radial dimension over the axial extent of the seal assembly.

3. A seal assembly according to claim 1, wherein axially successive lands on both components decrease in diameter stepwise over a first axial extent of the seal assembly and increase in diameter stepwise over a second axial extent of the seal assembly.

4. A seal assembly according to claim 1, wherein axially successive lands on both components increase in diameter stepwise over a first axial extent of the seal assembly and decrease in diameter stepwise over a second axial extent of the seal assembly.

5. A seal assembly according to claim 1, wherein at least one of the rows of fins on the rotary component, on the static component, or both, comprises a single fin.

6. A seal assembly according to claim 1, wherein at least one of the rows of fins on the rotary component, on the static component, or both, comprises a double fin.

7. A seal assembly according to claim 1, wherein at least one of the rows of fins on the rotary component, on the static component, or both, comprises a multiple fin.

8. A seal assembly according to claim 6, further comprising:
circumferentially extending elongate components having a substantially U-shaped cross-section; and
wherein the double fin comprises radially projecting free ends of the circumferentially extending elongate components.

9. A seal assembly according to claim 8, wherein the static component comprises a static shroud ring;
further comprising grooves formed in the confronting lands on the rotor and on the static shroud ring; and
wherein the circumferentially extending elongate components are secured in the grooves in the confronting lands on the rotor and on the static shroud ring, the cross-sectional shape of the grooves being complementary to the U-shaped cross-section of the elongate components.

10. A seal assembly according to claim 1, wherein the spacing between successive rows of fins on the rotary component differs from the spacing between successive rows of fins on the static component to produce a vernier seal arrangement.

11. A seal assembly according to claim 1, wherein the spacing between successive rows of fins on either or both components is unequal.

12. A seal assembly according to claim 2, wherein axially successive lands on both components decrease in diameter stepwise over a first axial extent of the seal assembly and increase in diameter stepwise over a second axial extent of the seal assembly.

13. A seal assembly according to claim 2, wherein axially successive lands on both components increase in diameter stepwise over a first axial extent of the seal assembly and decrease in diameter stepwise over a second axial extent of the seal assembly.

14. A seal assembly according to claim 7, further comprising:
circumferentially extending elongate components having a substantially U-shaped cross-section; and
wherein the multiple fins comprise radially projecting free ends of the circumferentially extending elongate components.

15. A seal assembly according to claim 14, wherein the static component comprises a static shroud ring;
further comprising grooves formed in the confronting lands on the rotor and on the static shroud ring; and
wherein the circumferentially extending elongate components are secured in the grooves in the confronting lands on the rotor and on the static shroud ring, the cross-sectional shape of the grooves being complementary to the U-shaped cross-section of the elongate components.
